(19) United States
(12) Patent Application Publication
(10) Pub. No.: US 2006/0146774 A1
(43) Pub. Date: Jul. 6, 2006

(54) METHOD FOR PROCESSING VOICE COMMUNICATION IN SHORT RANGE COMMUNICATION

(75) Inventors: Min Jung Kim, Geumcheon-gu (KR); Jin Ho Son, Gwacheon-si (KR); Chan Phil Yun, Gwacheon-si (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,385

(22) Filed: Dec. 29, 2005

(30) Foreign Application Priority Data
Jan. 3, 2005 (KR) 10-2005-0000253

(51) Int. Cl. H04Q 7/24

(52) U.S. Cl. 370/338; 370/401

(57) ABSTRACT

The present invention establishes an SCO link between a CTP gateway and a headset so that voice packets can be transmitted directly to each other. In the present invention, a CTP terminal is connected to the CTP gateway through CTP, and the headset is connected to the CTP terminal through HSP/HFP. If the headset requests origination of a call or a call terminates at the CTP gateway in a scatternet state where the headset is connected to the CTP gateway via an ACL link, an SCO link is established between the CTP gateway and the headset through intervention of the CTP terminal, and voice packets for a voice communication are transmitted to each other via the established SCO link.

This application claims the benefit of the Korean Application No. 10-2005-0000253 filed on Jan. 3, 2005, which is hereby incorporated by reference.

### I. BACKGROUND OF THE INVENTION

1. Field of the Invention

The present invention relates to a method for processing a voice communication in short range communication.

2. Description of the Related Art

The WPAN (Wireless Personal Area Network) is a communication network having a relatively small number of terminals as members of the network in a short range, i.e., within a radius of 10 m or less, using wireless channels. Well-known typical WPAN technologies include UWB (Ultra Wide Band) communication, Bluetooth, WLANs (Wireless Local Area Networks), Zigbee modules, IrDA (Infrared Data Association) communication, and the like.

The WPAN is to replace wired communication with wireless communication and is used in a variety of short range communication fields, and it is expected that applicable fields thereof will be expanded continuously.

Bluetooth, which is a representative short range communication technology spotlighted recently, continuously advances after the Bluetooth specification version 1.0 is announced as official standards by the Bluetooth SIG (Special Interest Group) organized by Ericsson, Nokia, IBM, Toshiba, and Intel. The IEEE 802.15 Working Group has been founded as an official international standard organization for this technology, which is in close cooperation with the SIG in order to establish international standards based on the Bluetooth specification.

In Bluetooth, the maximum data transmission rate is 1 Mbps (an effective transmission rate in consideration of a packet header is 433.9 kbps in opposite directions, or 723.2 kbps in one direction and 57.6 kbps in the other direction). A transmission distance is about 10 m or less when transmission power is 1 mW, and the maximum transmission power is specified as 100 mW.

In Bluetooth, 79 channels with a bandwidth of 1 MHz are set in the ISM (Industrial, Scientific, and Medical) band of 2.4000-2.4835 GHz that users can utilize without licenses, and the channels are changed about 1,600 times per second in the frequency hopping spread spectrum scheme so as to transmit data.

Since Bluetooth uses the frequency hopping spread spectrum scheme, there is an advantage in that data can be correctly transmitted even in wireless communication environment with severe noises, and frequency interference can be avoided by hopping to the frequency of a new channel after transmitting and receiving a certain packet. Therefore, Bluetooth can hop faster than other systems that operate in the same frequency band, and more stably transmit data using shorter packets.

Recently, manufacturers of Bluetooth chips consecutively bring Bluetooth chips, which can support a scatternet, into the market. With the emergence of the Bluetooth chips capable of supporting the scatternet, communication can be made within a short range communication area of a cordless telephony profile gateway (hereinafter, referred to as “CTP gateway”), through a mobile terminal capable of supporting CTP (hereinafter, referred to as “CTP terminal”) and a Bluetooth headset connected to the CTP terminal by means of short range communication.

That is, the CTP terminal is connected to the CTP gateway through CTP (CTP connection) within a short range communication area of the CTP gateway so as to form a piconet. Then, through HSP/HFP (Headset Profile/Hands-free Profile), the headset is connected to the CTP terminal (HSP/HFP connection).

Here, the CTP terminal functions as a master that is an audio gateway of HSP/HFP for the headset.

Therefore, the CTP gateway, the CTP terminal, and the headset form a scatternet.

In a state where the CTP gateway, the CTP terminal, and the headset are connected through the scatternet in this way, when a user performs a voice communication through the headset, the CTP terminal and the CTP gateway forward voice packets to each other via an SCO (Synchronous Connection Oriented) link, and the CTP terminal and the headset supporting HSP/HFP forward the voice packets to each other via an SCO link.

Accordingly, the user can perform a voice communication using the headset in response to a call terminated at or originated from the CTP gateway through a PSTN (Public Switched Telephone Network). Further, for a call terminating at or originated from the CTP terminal, the user can perform a voice communication using the headset.

When the user performs a voice communication for a call terminating at or originated from the CTP gateway using the headset, the CTP terminal should be connected to the CTP gateway and the headset via SCO links, respectively.

If a Bluetooth device forms two or more SCO links for transmitting voice packets to other Bluetooth devices, the type of voice packet to be used should be always HV3 (Header Value 3). In HV3, TX packets should be transmitted in every six time slots, and RX packets should be received in every six time slots. The starting point of a time slot for transmitting a voice packet between Bluetooth devices is determined by the Bluetooth device address of a Bluetooth device functioning as a master, and time slots of two piconets cannot be identical with each other. That is, time slots through which the CTP gateway and the CTP terminal transmit voice packets cannot be identical with time slots through which the CTP terminal and the headset transmit voice packets.

Therefore, when the CTP gateway, the CTP terminal, and the headset form a scatternet, the CTP terminal, which is a connection device to the scatternet, should use all the six time slots: two time slots used between the CTP gateway and the CTP terminal, two time slots used between the CTP terminal and the headset, and two time slots spared for buffering time difference between time slots of two piconets.

In a case where the CTP terminal uses all the six time slots in this way so that the user is allowed to perform a voice communication through the headset, if a certain control command such as call release is to be transmitted, there is no time slot for transmitting the control command.

In this case, a conventional scheme creates a DV (Data and Voice) packet and transmits data on a control command together with voice information, or transmits a data packet of the control command rather than voice information to a time slot for transmitting the voice information.

If the control command data are transmitted together with the voice information through the DV packet, the amount of voice information to be transmitted is reduced by half. On the other hand, if the data packet of the control command is transmitted to the time slot for transmitting voice information, the corresponding time slot cannot transmit voice information. Therefore, there occurs a phenomenon in which communicating voices are not continued but are interrupted whenever a DV packet or a data packet of a control command is transmitted.

In addition, when the CTP gateway and the headset transmit voice information to each other, two SCO links are used through the CTP terminal, which causes a time delay for transmitting voice information via the SCO links, and the relay of the voice information by the CTP terminal causes an additional time delay. That is, a time delay of 0.6 ms occurs in transmitting voice information between the CTP gateway and the CTP terminal via the SCO link, and a time delay of 0.6 ms occurs in transmitting voice information between the CTP terminal and the headset via the SCO link. Therefore, a time delay of a total of 1.2 ms occurs in transmitting voice information between the CTP gateway and the headset via the SCO links, and the relay of the voice information by the CTP terminal causes an additional time delay.

In addition, since voice information is transmitted via two SCO links, relatively lower voice quality is provided as compared with that of the voice information transmitted via one SCO link.

Moreover, since the CTP terminal serves both as an SCO link to the CTP gateway and an SCO link to the headset, power consumption increases almost twice as compared with a case where a voice communication is performed through the CTP terminal.

### (a) SUMMARY OF THE INVENTION

Therefore, it is an object of the present invention to provide a method for processing a voice communication in short range communication, wherein when a user performs a voice communication through a headset, an SCO link is established between a CTP gateway and the headset and a voice packet is transmitted to each other via the link.

It is another object of the present invention to provide a method for processing a voice communication in short range communication, wherein a CTP gateway and a headset forward a call to each other to perform a voice communication.

According to an aspect of the present invention for achieving the objects, there is provided a method for processing a voice communication in short range communication, comprising: forming a scatternet by a CTP gateway, a CTP terminal and a headset; and establishing an SCO link between the CTP gateway and the headset through intervention of the CTP terminal, and performing a voice communication.

The step of forming the scatternet may comprise: requesting, by the headset, the CTP terminal to make HSP/HFP connection in a piconet state where the CTP terminal is connected to the CTP gateway through CTP; and making, by the CTP terminal, the HSP/HFP connection to the headset in response to the HSP/HFP connection request, and connecting the headset to the CTP gateway via an ACL link through intervention of the CTP terminal. The step of connecting the headset to the CTP gateway via the ACL link may comprise: informing, by the CTP terminal, the headset of a Bluetooth device address of the CTP gateway, and setting a paging scan mode so that the headset can wait for connection to the CTP gateway; requesting, by the CTP terminal, the CTP gateway to register the headset as a HSP/HFP terminal; and connecting the headset to the CTP gateway via the ACL link in response to the registration request.

The step of forming the scatternet may comprise: connecting the headset to the CTP terminal through HSP/HFP in response to a request of the CTP terminal, in a piconet state where the CTP terminal is connected to the CTP gateway through CTP; and connecting the headset to the CTP gateway via an ACL link through intervention of the CTP terminal. The step of connecting the headset to the CTP gateway via the ACL link may comprise: the steps of informing, by the CTP terminal, the headset of a Bluetooth device address of the CTP gateway, and setting a paging scan mode so that the headset can wait for connection to the CTP gateway; requesting, by the CTP terminal, the CTP gateway to register the headset as a HSP/HFP terminal; and connecting the headset to the CTP gateway via the ACL link in response to the registration request.

The step of forming the scatternet may comprise: connecting the CTP terminal to the CTP gateway through CTP in response to a request of the CTP terminal, in a piconet state where the headset is connected to the CTP terminal through HSP/HFP; and connecting the headset to the CTP gateway via an ACL link through intervention of the CTP terminal. The step of connecting the headset to the CTP gateway via the ACL link may comprise: informing, by the CTP terminal, the headset of a Bluetooth device address of the CTP gateway, and setting a paging scan mode so that the headset can wait for connection to the CTP gateway; requesting, by the CTP terminal, the CTP gateway to register the headset as a HSP/HFP terminal; and connecting the headset to the CTP gateway via the ACL link in response to the registration request.

The step of establishing the SCO link may comprise: making, by the headset, a request for origination of a call to a specific number; transmitting, by the CTP terminal, the request for origination of the call to the specific number to the CTP gateway, and requesting SCO link connection between the CTP gateway and the headset; and originating, by the CTP gateway, the call to the specific number, and connecting the headset to the CTP gateway via the SCO link. The request for origination of the call to the specific number may be a request for origination of a call to a number in response to AT+CKPD, AT+ATD or AT+BLDN.

The step of establishing the SCO link may comprise: requesting, by the CTP terminal, the CTP gateway to originate a call to a specific number and to make SCO link connection to the headset; and originating, by the CTP gateway, the call to the specific number, and connecting the headset to the CTP gateway via the SCO link.

The step of establishing the SCO link may comprise: informing the headset of the receipt of the call through the CTP terminal if a call terminates at the CTP gateway; requesting, by the CTP terminal, the CTP gateway to permit a communication for the call and to make SCO link connection to the headset if the headset requests a communication for the terminating call; and connecting the headset to the CTP gateway via the SCO link in response to the request.

The method of the present invention may further comprise: requesting, by the headset, call forwarding while a voice communication is performed through the headset; and establishing an SCO link between the CTP gateway and the CTP terminal in response to the call forwarding request so that a telephone communication can be performed, and closing the SCO link established between the CTP gateway and the headset. The method of the present invention may further comprise: requesting, by the CTP terminal, call forwarding while a voice communication is performed through the CTP terminal; and establishing an SCO link between the CTP gateway and the headset in response to the call forwarding request so that a telephone communication can be performed, and closing the SCO link established between the CTP gateway and the CTP terminal.

The method of the present invention may further comprise: closing the SCO link if release of a call is requested. The call release may be requested by the headset. Alternatively, the call release may be requested by a counterpart of the communication connected to the CTP gateway.

According to another aspect of the present invention, there is provided a method for processing a voice communication in short range communication, comprising: forming a scatternet by connecting a CTP terminal to a CTP gateway through CTP and connecting a headset to the CTP terminal through HSP/HFP; connecting the headset to the CTP gateway via an ACL link through intervention of the CTP terminal in the state where the scatternet has been formed; and if the headset requests origination of a call, originating, by the CTP gateway, a call through intervention of the CTP terminal, and connecting the headset to the CTP gateway via an SCO link so that a voice communication can be performed.

According to a further aspect of the present invention, there is provided a method for processing a voice communication in short range communication, comprising: forming a scatternet by connecting a CTP terminal to a CTP gateway through CTP and connecting a headset to the CTP terminal through HSP/HFP; connecting the headset to the CTP gateway via an ACL link through intervention of the CTP terminal in the state where the scatternet has been formed; and if a call terminates at the CTP gateway, connecting the headset to the CTP gateway via an SCO link through intervention of the CTP terminal so that a voice communication can be performed.

The method of the present invention may further comprise: establishing, by the CTP gateway, an SCO link to the CTP terminal or the headset, and forwarding a call if the headset or the CTP terminal requests call forwarding.

### II. BRIEF DESCRIPTION OF THE DRAWINGS

The above and other objects, features and advantages of the present invention will become apparent from the following description of preferred embodiments given in conjunction with the accompanying drawings, in which:

FIG. 1 is a diagram illustrating an operation by which a CTP gateway, a CTP terminal and a headset form a scatternet to perform a voice communication;

FIG. 2 is a diagram illustrating a method of processing a voice communication according to an embodiment of the present invention, wherein a scatternet is formed in response to a request of a headset in a piconet state where a CTP terminal is connected to a CTP gateway;

FIG. 3 is a diagram illustrating a method of processing a voice communication according to another embodiment of the present invention, wherein a scatternet is formed by connecting a headset in response to a request of a CTP terminal in a piconet state where a CTP terminal is connected to a CTP gateway;

FIG. 4 is a diagram illustrating a method of processing a voice communication according to a further embodiment of the present invention, wherein a scatternet is formed by connecting a CTP gateway in a piconet state where a headset is connected to a CTP terminal;

FIG. 5 is a diagram illustrating an operation in a call-originating mode established through a headset in the method of processing a voice communication according to the present invention;

FIG. 6 is a diagram illustrating an operation in a call-originating mode established through a CTP terminal in the method of processing a voice communication according to the present invention;

FIG. 7 is a diagram illustrating an operation in a call-receiving mode in the method of processing a voice communication according to the present invention;

FIG. 8 is a diagram illustrating an operation of forwarding a voice communication performed through a headset to a CTP terminal in the method of processing a voice communication according to the present invention; and

FIG. 9 is a diagram illustrating an operation of forwarding a voice communication performed through a CTP terminal to a headset in the method of processing a voice communication according to the present invention.

### DETAILED DESCRIPTION OF THE INVENTION

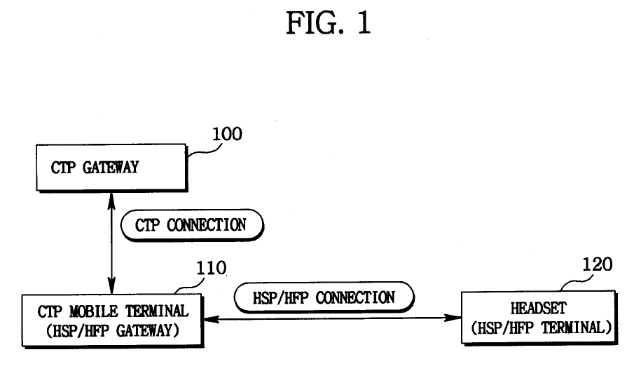

FIG. 1 is a diagram illustrating an operation by which a CTP gateway, a CTP terminal and a headset form a scatternet to perform a voice communication. Here, reference numeral 100 designates the CTP gateway, and reference numeral 110 designates the CTP terminal. The CTP gateway (100) functions as a master, and the CTP terminal (110) functions as a slave. The CTP terminal (110) is connected through CTP to the CTP gateway (100) in short range communication.

Reference numeral 120 designates the headset. The headset (120) is connected to the CTP terminal (110) through HSP/HFP (Headset Profile/Hands-free Profile). The CTP terminal (110) functions as a master, which is an audio gateway capable of supporting HSP/HFP, for the headset (120). The headset (120) functions as a slave that is an HSP/HFP terminal.

Therefore, the CTP gateway (100), the CTP terminal (110), and the headset (120) form a scatternet.

When the CTP gateway (100), the CTP terminal (110), and the headset (120) form the scatternet in this way, the CTP gateway (100) and the CTP terminal (110) forward voice packets to each other via an SCO (Synchronous Connection Oriented) link. In addition, the CTP terminal (110) and the headset (120), which support HSP/HFP, forward voice packets to each other via another SCO link.

Therefore, for a call that is made by means of connection of the CTP terminal (110) to a wireless telephone network, a user can perform a voice communication through the headset (120). In addition, for a call that is made by means of connection of the CTP gateway (100) to a wired telephone network of a PSTN (Public Switched Telephone Network), the user can also perform a voice communication through the headset (120).

When the user performs a voice communication for a call, which is connected to the CTP gateway (100), through the headset (120), voice packets are forwarded via the SCO link between the CTP gateway (100) and the CTP terminal (110), and the SCO link between the CTP terminal (110) and the headset (120). That is, voice packets for a voice communication are forwarded via the two SCO links between the CTP gateway (100) and the headset (120).

In this case, it is desirable to establish an SCO link for transmitting voice packets between the CTP gateway (100) and the headset (120) so that voice packets can be forwarded via only one SCO link.

In order to transmit voice packets between the CTP gateway (100) and the headset (120) via an SCO link, it is necessary to expand HSP/HFP and CTP. In Bluetooth communication, HSP/HFP and CTP have been adapted to be connected to only one device. Accordingly, in order to allow two Bluetooth devices to exchange certain data between each other, an SCO link is allowed to be established only after an ACL (Asynchronous Connectionless) link is established.

In the present invention, HSP/HFP and CTP should know in advance that an additional device exists besides the currently connected devices, and recognize that they should establish an SCO link to the additional device. That is, in the present invention, the CTP gateway (100) is informed of the presence of the headset (120). Further, the headset (120) is informed of the presence of the CTP gateway (100). Then, the CTP gateway (100) and the headset (120) establish an SCO link therebetween.

Therefore, in order to allow the CTP gateway (100) and the headset (120) to transmit voice packets to each other via an SCO link in the present invention, the CTP gateway (100), the CTP terminal (110), and the headset (120) should form a scatternet.

In order to explain the method for processing a voice communication according to the present invention, an operation of forming a scatternet by the CTP gateway (100), the CTP terminal (110) and the headset (120), and operations of originating, receiving and forwarding a call by the headset through the scatternet will be described in sequence.

The operation of forming a scatternet can be roughly divided into two types. First, the headset (120) is added in a piconet state where the CTP terminal (110) is connected to the CTP gateway (100) through CTP, thereby forming a scatternet. Second, the CTP terminal (110) is connected to the CTP gateway (100) in short range communication in a piconet state where the headset (120) is connected to the CTP terminal (110) through HSP/HFP, thereby forming a scatternet.

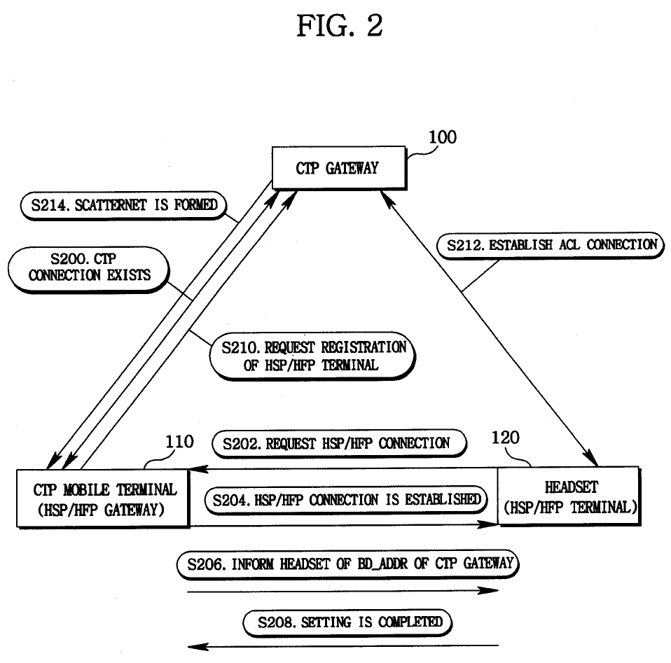

FIG. 2 is a diagram illustrating a method for processing a voice communication according to an embodiment of the present invention, wherein a scatternet is formed in response to a request of a headset (120) in a piconet state where a CTP terminal (110) is connected to a CTP gateway (100). As illustrated in FIG. 2, when the headset (120) is to be connected to the CTP terminal (110) in a piconet state where the CTP terminal (110) is connected to the CTP gateway (100) through CTP (S200), the headset (120) requests HSP/HFP connection (S202).

Then, the CTP terminal (110) makes connection to the headset (120) through HSP/HFP in response to the HSP/HFP connection request (S204).

Here, since the CTP gateway (100) and the CTP terminal (110) have already formed the piconet through CTP, the CTP terminal (110) has known the Bluetooth device address (BD_ADDR) of the CTP gateway (100). The CTP terminal (110) transmits the Bluetooth device address (BD_ADDR) of the CTP gateway (100), together with a guide message for commanding to wait for connection to the CTP gateway (100), to the headset (120) (S206). Then, the headset (120) waits for connection to the CTP gateway 100 with the corresponding Bluetooth device address, and does not make connection to any other devices with other Bluetooth device addresses.

Next, the headset (120) sets a communication mode to a paging scan mode in response to the guide message, and informs the CTP terminal (110) of completion of the setting of the communication mode (S208).

In this state, the CTP terminal (100) informs the CTP gateway (100) of the Bluetooth device address of the headset (120), and requests the CTP gateway to register the headset as a HSP/HFP terminal (S210). Then, the CTP gateway (100) establishes an ACL (Asynchronous Connectionless) link to the headset (120) using the Bluetooth device address of the headset (120) in response to the registration request (S212).

That is, when the CTP gateway (100) receives the Bluetooth device address of the headset (120), it records information on the headset (120) in a WUG (Wireless User Group), and establishes an ACL link connection to the headset (120) so that the headset (120) can be controlled through short range communication.

When the ACL link connection has been completely established, the CTP gateway (100) finally informs the CTP terminal (110) of the completion of the link establishment so that the CTP terminal (110) can be informed that a scatternet has been formed in response to the request of the headset (120) (S214).

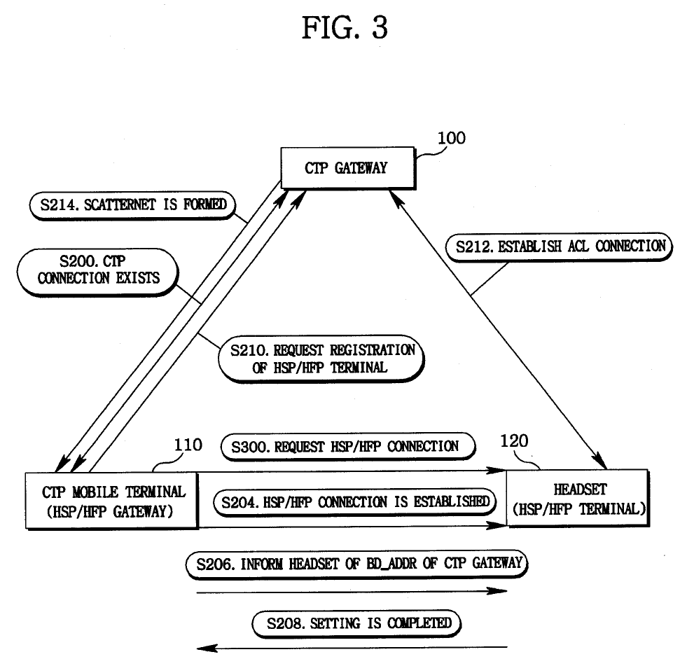

The embodiment of the present invention of FIG. 2 is to illustrate the operation of forming a scatternet when the headset (120) requests the CTP terminal (110) to make HSP/HFP connection. Contrary to FIG. 2, as in another embodiment illustrated in FIG. 3, the CTP terminal (110) may request the headset 120 to make HSP/HFP connection so that a scatternet can be formed. As for the operation in which the CTP terminal (110) requests the headset 120 to make HSP/HFP connection so that a scatternet can be formed, only the operation of requesting HSP/HFP connection by the CTP terminal (110) (S300) is performed in a direction opposite to that of the corresponding operation in the previous embodiment. Since the other operations (S200, S204-214) are performed in the same manner as those of the previous embodiment, detailed descriptions thereof will be omitted.

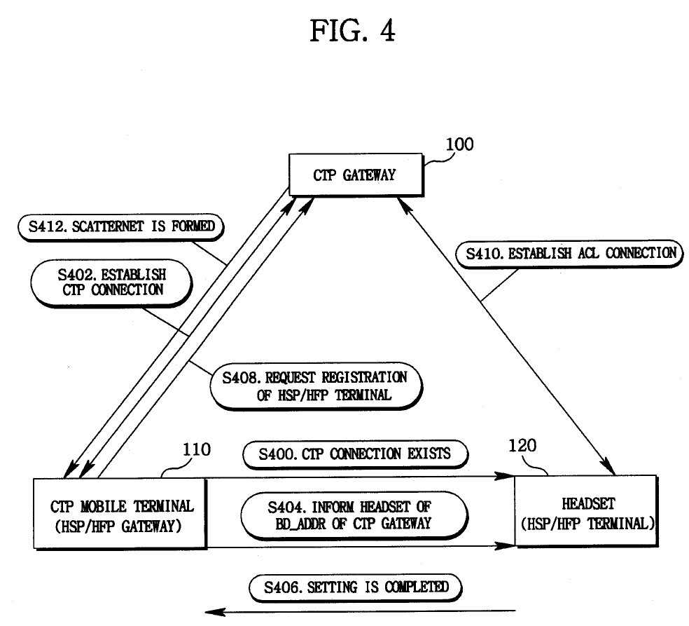

FIG. 4 is a diagram illustrating a method of processing a voice communication according to a further embodiment of the present invention, wherein a scatternet is formed by connecting a CTP gateway (100) in a piconet state where a headset (120) is connected to a CTP terminal (110). As illustrated in FIG. 4, in a piconet state where the headset (120) is connected to the CTP terminal (110) through HSP/HFP (S400), the CTP terminal (110) requests the CTP gateway (100) to make CTP connection so that CTP connection can be established (S402).

When the CTP connection is established between the CTP gateway (100) and the CTP terminal (110), the CTP terminal (110) transmits the Bluetooth device address (BD_ADDR) of the CTP gateway (100), together with a guide message for commanding to wait for connection to the CTP gateway (100), to the headset (120) (S404).

The headset (120) sets a communication mode to a paging scan mode in response to the guide message, and informs the CTP terminal (110) of completion of the setting of the communication mode (S406).

In this state, the CTP terminal (100) informs the CTP gateway (100) of the Bluetooth device address of the headset (120), and requests the CTP gateway to register the headset as a HSP/HFP terminal (S408).

The CTP gateway (100) establishes an ACL (Asynchronous Connectionless) link to the headset (120) using the Bluetooth device address of the headset (120) in response to the registration request (S410). That is, when the CTP gateway (100) receives the Bluetooth device address of the headset (120), it records information on the headset (120) in a WUG, and establishes an ACL (CTP_AG merge_extended ACL) link connection to the headset (120) so that the headset (120) can be controlled through communication.

When the ACL link connection has been completely established, the CTP gateway (100) finally informs the CTP terminal (110) that the formation of a scatternet has been completed (S412).

Descriptions of a call-originating mode, a call-receiving mode and an operation of forwarding a voice communication in the state where the CTP gateway (100), the CTP terminal (110) and the headset (120) have formed a scatternet as described above will be made below.

The call-originating mode is divided into a call-originating mode established through the headset (120) and a call-originating mode established through the CTP terminal (110).

The call-originating mode established through the headset (120) will be first explained.

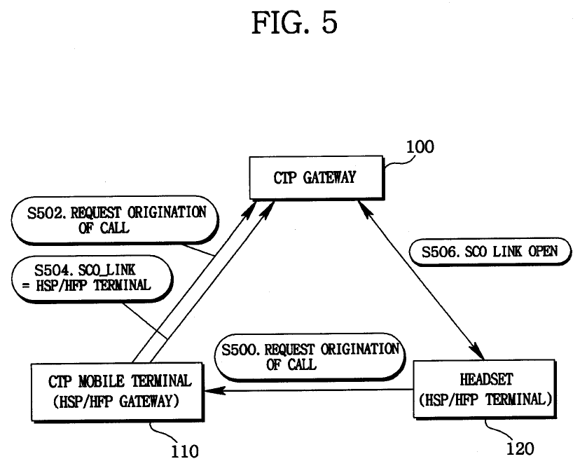

FIG. 5 is a diagram illustrating an operation in a call-originating mode established through the headset in the method of processing a voice communication according to the present invention. As shown in FIG. 5, the headset (120) requests, through HSP/HFP, the CTP terminal (110) to originate a call to a specific number (S500). Here, the headset (120) transmits the specific number to the CTP terminal (110) by means of a HSP/HFP message (AT+CKPD, AT+ATD, AT+BLDN).

The CTP terminal 110 requests, through CTP, the CTP gateway 100 to originate a call to the specific number in response to the HSP/HFP message (S502), and transmits a ‘SCO_LINK=HSP/HFP terminal’ message, which is SCO link connection information for commanding to make connection to the headset (120) via an SCO link, to the CTP gateway (100) (S504).

Then, the CTP gateway (100) originates a call to the specific number in response to the call-originating request and makes connection to the headset (120) via an SCO link in response to the transmitted SCO link connection information, so that a user can perform a voice communication through the headset (120) (S506). That is, the CTP gateway (100) and the headset (120) transmit voice packets to each other via the SCO link.

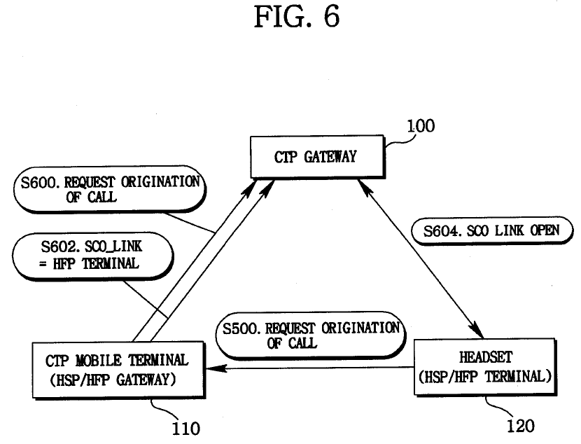

FIG. 6 is a diagram illustrating an operation in a call-originating mode established through the CTP terminal (100) in the method of processing a voice communication according to the present invention. As illustrated in FIG. 6, the CTP terminal (110) requests, through CTP, the CTP gateway 100 to originate a call to a specific number (S600). In addition, the CTP terminal (110) transmits a ‘SCO_LINK=HSP/HFP terminal’ message, which is SCO link connection information for commanding to make connection to the headset (120) via an SCO link, to the CTP gateway (100) (S602)

Then, the CTP gateway (100) originates a call to the specific number in response to the call-originating request and makes connection to the headset (120), which is a HSP/HFP terminal, via the SCO link in response to the SCO link connection information, so that a user can perform a voice communication through the headset (120) (S604).

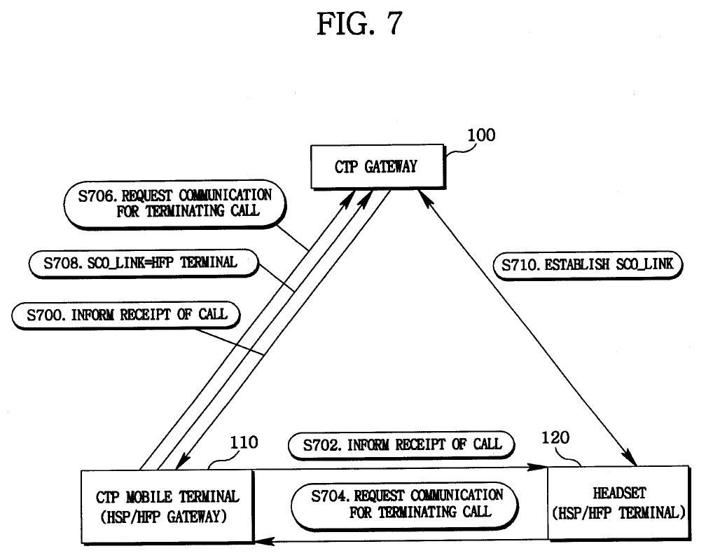

FIG. 7 is a diagram illustrating an operation in a call-receiving mode in the method of processing a voice communication according to the present invention. As illustrated in FIG. 7, when the CTP gateway (100) receives a terminating call, the CTP gateway (100) informs the CTP terminal (110) of the receipt of the call through CTP (S700).

Then, the CTP terminal (110) informs the headset (120) of the receipt of the call through HSP/HFP (S702).

In this state, if the user manipulates the headset (120) and instructs the headset to perform a voice communication for the terminating call, the headset (120) requests the CTP terminal (110) to permit a communication for the terminating call (S704).

In response to the communication request of the headset (120), the CTP terminal (110) requests the CTP gateway (100) to permit a communication for the terminating call (S706). Then, the CTP terminal (110) transmits a ‘SCO_LINK=HSP/HFP terminal’ message, which is voice link connection information for commanding to make connection to the headset (120) via an SCO link, to the CTP gateway (100) (S708).

Then, the CTP gateway (100) establishes an SCO link to the headset (120) in response to the voice link connection information (S710), so that the user can perform a voice communication for the terminating call through the headset (120).

In the foregoing, a case where a user performs a voice communication for a call terminating at the CTP gateway (100) through the headset (120) has been explained by way of example. According to an embodiment of the present invention, a user can perform a voice communication for a call terminating at the CTP gateway (100) using the CTP terminal (110).

When a user performs a voice communication using the CTP terminal (110), the process in which the CTP terminal (110) informs the headset (120) of the receipt of a call (S702) and a process in which the headset (120) requests a communication for the terminating call (S704) are not performed. When the CTP gateway (100) informs the receipt of a call, the CTP terminal (110) requests a communication for the terminating call in response to a user's manipulation (S706) and establishes an SCO link to the CTP gateway (100) so that the user can perform a voice communication.

On the other hand, while performing a voice communication using the CTP terminal (110), the user can forward the call to the headset (120) and perform the voice communication. Alternatively, while performing a voice communication using the headset (120), the user can forward the call to the CTP terminal (110) and perform the voice communication.

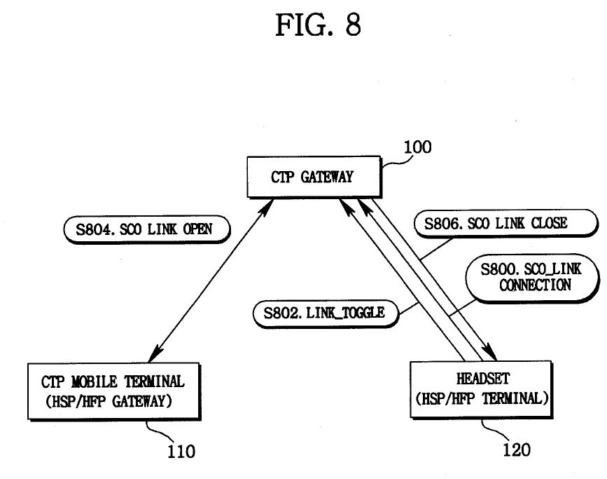

FIG. 8 is a diagram illustrating an operation of forwarding a voice communication performed through the headset (120) to the CTP terminal (110) in the method of processing a voice communication according to the present invention. As illustrated in FIG. 8, an SCO link is established between the CTP gateway (100) and the headset (120) so that a user can perform a voice communication using the headset (120) (S800).

In this state, if the user manipulates the headset (120) and commands to forward the voice communication to the CTP terminal (110), the headset (120) creates a ‘SCO_LINK_TOGGLE’ message, which is a toggle message of an SCO link, and transmits the message to the CTP gateway (100) (S802).

Then, the CTP gateway (100) establishes an SCO link to the CTP terminal (110) in response to the ‘SCO_LINK_TOGGLE’ message, which is a toggle message of the SCO link, so that voice packets for the voice communication can be transmitted to each other (S804). In addition, the CTP gateway (100) closes the SCO link established between the CTP gateway (100) and the headset (120) (SCO LINK CLOSE) (S806).

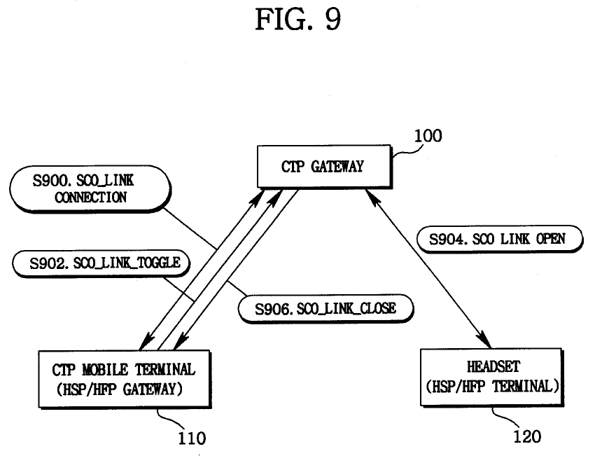

FIG. 9 is a diagram illustrating an operation of forwarding a voice communication performed through the CTP terminal to the headset in the method of processing a voice communication according to the present invention. As illustrated in FIG. 9, an SCO link is established between the CTP gateway (100) and the CTP terminal (110) so that a user can perform a voice communication using the CTP terminal (110) (S900).

In this state, if the user manipulates the CTP terminal (110) and commands to forward the voice communication to the headset (120), the CTP terminal (110) creates a ‘SCO_LINK_TOGGLE’ message, which is a toggle message of an SCO link, and transmits the message to the CTP gateway (100) (S902).

Then, the CTP gateway (100) establishes an SCO link to the headset (120) in response to the ‘SCO_LINK_TOGGLE’ message, which is a toggle message of the SCO link, so that voice packets for the voice communication can be transmitted to each other (S904). Further, the CTP gateway (100) closes the SCO link established between the CTP gateway (100) and the CTP terminal (110) (SCO LINK CLOSE) (S906).

Cases where a user releases a call while performing a voice communication using the CTP terminal (110) or the headset (120) include the following three cases.

There are a first case where the user releases a call while performing a voice communication by means of establishment of an SCO link between the CTP gateway (100) and the CTP terminal (110), a second case where the user releases a call while performing a voice communication by means of establishment of an SCO link between the CTP gateway (100) and the headset (120), and a third case where a counterpart of a voice communication releases a call.

In the first case, if the user manipulates the CTP terminal (110) and commands to release the call, the CTP terminal (110) informs the CTP gateway 100 of release of the call and releases the call by closing the SCO link.

In the second case, if the user manipulates the headset (120) and commands to release the call, the headset (120) closes the SCO link and informs the CTP terminal (110) of release of the call. The CTP terminal (110) informs the CTP gateway (100) of release of the call, and the CTP gateway (100) releases the call.

In the third case, if the counterpart of a communication releases the call, the CTP gateway (100) informs the CTP terminal (110) of release of the call. The CTP terminal (110) informs the headset (120) of release of the call, and an SCO link established between the headset (120) and the CTP gateway (100) is closed.

As described above, in the present invention, a CTP gateway, a CTP terminal, a headset form a scatternet. In the scatternet, an SCO link is established between the CTP gateway and the headset so that voice packets for a voice communication can be transmitted to each other.

Therefore, the CTP gateway and the headset transmit voice packets to each other via only one SCO link, thereby enhancing the quality of a voice communication and reducing a delay of communicating voices as well.

When a user performs a voice communication using the CTP terminal, an SCO link is established between the CTP gateway and the CTP terminal. When the user performs a voice communication using the headset, the CTP terminal does not establish an SCO link, resulting in reduced power consumption of the CTP terminal.

Although the present invention has been described and illustrated in connection with the preferred embodiments, it will be apparent that various modifications and changes can be made thereto without departing from the scope of the present invention. Therefore, the scope of the present invention should not be defined by the embodiments but should be defined by the appended claims and equivalents thereof.

What is claimed is:

1. A method for processing a voice communication in short range communication, comprising:
forming a scatternet by a CTP gateway, a CTP terminal and a headset; and
establishing an SCO link between the CTP gateway and the headset through intervention of the CTP terminal, and performing a voice communication.

2. The method as claimed in claim 1, wherein the step of forming the scatternet comprises:
requesting, by the headset, the CTP terminal to make HSP/HFP connection in a piconet state where the CTP terminal is connected to the CTP gateway through CTP; and
making, by the CTP terminal, the HSP/HFP connection to the headset in response to the HSP/HFP connection request, and connecting the headset to the CTP gateway via an ACL link through intervention of the CTP terminal.

3. The method as claimed in claim 2, wherein the step of connecting the headset to the CTP gateway via the ACL link comprises:
informing, by the CTP terminal, the headset of a Bluetooth device address of the CTP gateway, and setting a paging scan mode so that the headset can wait for connection to the CTP gateway;
requesting, by the CTP terminal, the CTP gateway to register the headset as a HSP/HFP terminal; and
connecting the headset to the CTP gateway via the ACL link in response to the registration request.

4. The method as claimed in claim 1, wherein the step of forming the scatternet comprises:
connecting the headset to the CTP terminal through HSP/HFP in response to a request of the CTP terminal, in a piconet state where the CTP terminal is connected to the CTP gateway through CTP; and
connecting the headset to the CTP gateway via an ACL link through intervention of the CTP terminal.

5. The method as claimed in claim 4, wherein the step of connecting the headset to the CTP gateway via the ACL link comprises:
informing, by the CTP terminal, the headset of a Bluetooth device address of the CTP gateway, and setting a paging scan mode so that the headset can wait for connection to the CTP gateway;
requesting, by the CTP terminal, the CTP gateway to register the headset as a HSP/HFP terminal; and
connecting the headset to the CTP gateway via the ACL link in response to the registration request.

6. The method as claimed in claim 1, wherein the step of forming the scatternet comprises:
connecting the CTP terminal to the CTP gateway through CTP in response to a request of the CTP terminal, in a piconet state where the headset is connected to the CTP terminal through HSP/HFP; and
connecting the headset to the CTP gateway via an ACL link through intervention of the CTP terminal.

7. The method as claimed in claim 6, wherein the step of connecting the headset to the CTP gateway via the ACL link comprises:
informing, by the CTP terminal, the headset of a Bluetooth device address of the CTP gateway, and setting a paging scan mode so that the headset can wait for connection to the CTP gateway;
requesting, by the CTP terminal, the CTP gateway to register the headset as a HSP/HFP terminal; and
connecting the headset to the CTP gateway via the ACL link in response to the registration request.

8. The method as claimed in claim 1, wherein the step of establishing the SCO link comprises:
making, by the headset, a request for origination of a call to a specific number;
transmitting, by the CTP terminal, the request for origination of the call to the specific number to the CTP gateway, and requesting SCO link connection between the CTP gateway and the headset; and
originating, by the CTP gateway, the call to the specific number, and connecting the headset to the CTP gateway via the SCO link.

9. The method as claimed in claim 8, wherein the request for origination of the call to the specific number is a request for origination of a call to a number in response to AT+CKPD, AT+ATD or AT+BLDN.

10. The method as claimed in claim 1, wherein the step of establishing the SCO link comprises:
requesting, by the CTP terminal, the CTP gateway to originate a call to a specific number and to make SCO link connection to the headset; and
originating, by the CTP gateway, the call to the specific number, and connecting the headset to the CTP gateway via the SCO link.

11. The method as claimed in claim 1, wherein the step of establishing the SCO link comprises:
informing the headset of the receipt of the call through the CTP terminal if a call terminates at the CTP gateway;
requesting, by the CTP terminal, the CTP gateway to permit a communication for the call and to make SCO link connection to the headset if the headset requests a communication for the terminating call; and
connecting the headset to the CTP gateway via the SCO link in response to the request.

12. The method as claimed in claim 1, further comprising:
requesting, by the headset, call forwarding while a voice communication is performed through the headset; and
establishing an SCO link between the CTP gateway and the CTP terminal in response to the call forwarding request so that a telephone communication can be performed, and closing the SCO link established between the CTP gateway and the headset.

13. The method as claimed in claim 12, further comprising:
requesting, by the CTP terminal, call forwarding while a voice communication is performed through the CTP terminal; and
establishing an SCO link between the CTP gateway and the headset in response to the call forwarding request so that a telephone communication can be performed, and closing the SCO link established between the CTP gateway and the CTP terminal.

14. The method as claimed in claim 1, further comprising the step of closing the SCO link if release of a call is requested.

15. The method as claimed in claim 14, wherein the call release is requested by the headset.

16. The method as claimed in claim 14, wherein the call release is requested by a counterpart of the communication connected to the CTP gateway.

17. A method of processing a voice communication in short range communication, comprising:
forming a scatternet by connecting a CTP terminal to a CTP gateway through CTP and connecting a headset to the CTP terminal through HSP/HFP;
connecting the headset to the CTP gateway via an ACL link through intervention of the CTP terminal in the state where the scatternet has been formed; and
originating, by the CTP gateway, a call through intervention of the CTP terminal, and connecting the headset to the CTP gateway via an SCO link so that a voice communication can be performed if the headset requests origination of a call.

18. The method as claimed in claim 17, further comprising the step of:
establishing, by the CTP gateway, an SCO link to the CTP terminal or the headset, and forwarding a call if the headset or the CTP terminal requests call forwarding.

19. A method of processing a voice communication in short range communication, comprising the steps of:
forming a scatternet by connecting a CTP terminal to a CTP gateway through CTP and connecting a headset to the CTP terminal through HSP/HFP;
connecting the headset to the CTP gateway via an ACL link through intervention of the CTP terminal in the state where the scatternet has been formed; and
connecting the headset to the CTP gateway via an SCO link through intervention of the CTP terminal so that a voice communication can be performed if a call terminates at the CTP gateway.

20. The method as claimed in claim 19, further comprising the step of:
establishing, by the CTP gateway, an SCO link to the CTP terminal or the headset, and forwarding a call if the headset or the CTP terminal requests call forwarding.
